(19) United States
(12) Patent Application Publication
(10) Pub. No.: US 2006/0170654 A1
(43) Pub. Date: Aug. 3, 2006

(54) No tilt joystick with CCD sensing

(75) Inventors: Andrew M. Voto, Brighton, MI (US); Ronald K. Selby, Flint, MI (US); Kenneth D. Perry, New Lothrop, MI (US); David A. Ross, Columbiaville, MI (US); Alfred V. Dumsa JR., Hartland, MI (US)

Correspondence Address: DELPHI TECHNOLOGIES, INC., M/C 480-410-202, PO BOX 5052, TROY, MI, 48007, US

(73) Assignee: Delphi Technologies, Inc., Troy, MI (US)

(21) Appl. No.: 11/178,680

(22) Filed: Jul. 11, 2005

Related U.S. Application Data
(60) Provisional application No. 60/649,456, filed on Feb. 2, 2005.

(51) Int. Cl. G09G 5/08

(52) U.S. Cl. 345/161

(57) ABSTRACT

A manually-operated control for generating a vector signal comprises first and second plates arranged in substantially parallel planes and being movable relative to each other in two directions while remaining substantially parallel. A non-tilt handle connected to one of the plates causes the relative movement of the plates. A CCD camera is fixed to one of the plates focused on the other plate. A microprocessor-based controller is connected to input and process images sequentially input from the camera for detecting and quantifying the relative movement of the two plates in two directions and generating a vector signal indicative thereof.

### CROSS REFERENCE TO RELATED APPLICATIONS

This application claims the benefit of U.S. Provisional Patent Application No. 60/649,456 filed Feb. 2, 2005, which is hereby incorporated by reference in its entirety.

### BACKGROUND OF THE INVENTION

1. Field of the Invention

This invention relates to manual controls similar to joystick controls useful in the operation of a motorized wheelchair. The manual controls have numerous other applications, such as in the operation of video games.

2. Description of Related Art

There is a need for inexpensive yet accurate manual controls for providing direction and speed signals for motorized wheelchairs. Controls of this type are often referred to as joystick controls. Typically, they are provided with a handle that is pivotally mounted for universal rotation about a point along its axis. Sensors are provided for sensing the angle of tilt along two perpendicular axes through the point of rotation. Numerous sensing schemes have been used, such as potentiometers in contact with brushes that move corresponding to the tilt of the joystick. See U.S. Pat. Nos. 4,856,785 and 6,259,433. Another sensing scheme involves the interaction of induction coils. See U.S. Pat. Nos. 4,879,556 and 5,911,627. Hall effect sensors have also been used for sensing the tilt. See U.S. Pat. Nos. 5,160,918 and 5,831,596.

Recently, the development of miniaturized cameras has been applied to the detection of the movement of computer mouse controls over surfaces. See U.S. Pat. Nos. 6,172,354 and 6,664,948 incorporated herein by reference. However, this technology has not yet been successfully applied to joystick-type controls and, in particular, controls for battery-operated joystick controlled wheelchairs. Computer mouse controls simply need to command relative movement of the mouse pointer on the computer monitor display. They need not detect absolute displacement from a home position.

A joystick control for a motorized wheelchair has several requirements. See, for example, U.S. Pat. Nos. 5,409,074 and 6,674,256 showing the use of joystick controls for commanding forward, reverse, right, and left motion of a motorized wheelchair. Controls for motorized wheelchairs may control individual motors on spaced wheels as shown in the two patents cited in this paragraph. Still more sophisticated wheelchair movement schemes are contemplated in which additional inputs are required. Hence, it is desirable that the manual control not only provides an indication of the displacement of the joystick handle but an indication of the rotation of the joystick handle around its axis.

Traditional joysticks that are pivotally mounted for universal rotation about two perpendicular axes are not easy for all handicapped individuals to use. The tilt movement required of the user's wrist may be impaired. However, if those users may have ample strength in the arms and shoulders they can operate a non-tilt manual control as disclosed herein.

### SUMMARY OF THE INVENTION

It is an advantage, according to the present invention, to provide a manual control comprising a non-tilt joystick that makes use of the CCD camera technology.

Briefly, there is provided a manually-operated control for generating a vector signal comprising first and second plates arranged in substantially parallel planes and being movable relative to each other in two directions while remaining substantially parallel to each other. A non-tilt handle connected to one of the plates may be gripped for causing the relative movement of the plates. A CCD camera is fixed to one of the plates and is focused on the other plate. An LED illuminates the area upon which the camera is focused. A microprocessor-based controller is connected to input and process images repeatedly input from the camera for detecting and quantifying the relative movement of the two plates in two directions and generating a vector signal indicative thereof.

Briefly, according to an alternate embodiment, there is provided a manually-operated control for generating a vector signal indicative of displacement of a non-tilt handle and a scalar signal indicative of the rotation of the handle comprising first and second plates arranged in substantially parallel planes and being relatively movable in translation and rotation while remaining substantially parallel. The handle is connected to one of the plates with an axis substantially perpendicular to the plate to which it is connected for causing the relative translation and rotation movement of the plates. In this embodiment, two spaced CCD cameras are fixed to one of said plates focused on the other plate. LEDs illuminate the area upon which the cameras are focused. A microprocessor-based controller is connected to input and process repeatedly input images from the cameras for detecting and quantifying the relative movement of the two plates in two directions and generating a vector signal indicative thereof and for detecting and quantifying the rotation of the handle about its axis.

The vector signal may comprise two signals each representative of a displacement from a home position taken along two directions which preferably are at right angles. Alternately, the vector signal may comprise a signal indicative of angular direction of the displacement and a signal indicative of the displacement from home in that direction.

In one specific implementation, the manually-operated control comprises a housing supporting a third plate substantially parallel to the first and second plates. The third plate is in sliding contact with either the first or second plate. The plate to which the handle is not connected has an opening therein through which the handle passes. A spring positioned between the plate to which the handle is connected and the housing urges the handle to return to a home position relative to the housing. A pattern on the plate on which the camera or cameras is focused serves to enable the camera and the microprocessor-based controller to determine when the handle is in the home position. Preferably, the plate to which to handle is attached has a circular shape and the handle is attached near the center of the plate. The housing provides a circular cavity adjacent the third plate for enclosing the plate attached to the handle and limiting the extent of the travel of the handle away from the home position. According to a most preferred embodiment, biasing of the handle to the home position is provided by a coil spring extending along the axis of the handle and secured at one end to the housing.

### BRIEF DESCRIPTION OF THE DRAWINGS

Further features and other objects and advantages will become apparent from the following detailed description made with reference to the drawings in which:

FIG. 1 is a sectioned perspective view of a non-tilt manually-operated controller according to one embodiment of the present invention;

FIG. 2 is an exploded view of the manually-operated controller as shown in FIG. 1; and

FIG. 3 is a schematic diagram of a computer method of detecting displacement according to the present invention.

### DESCRIPTION OF THE PREFERRED EMBODIMENTS

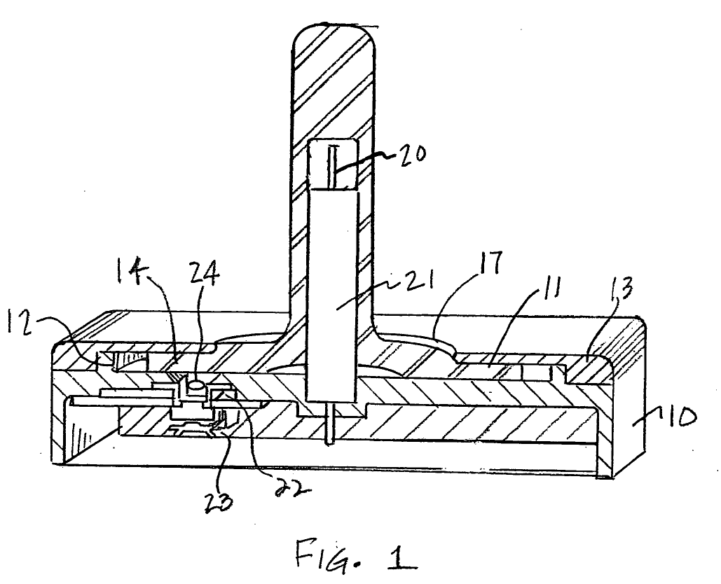

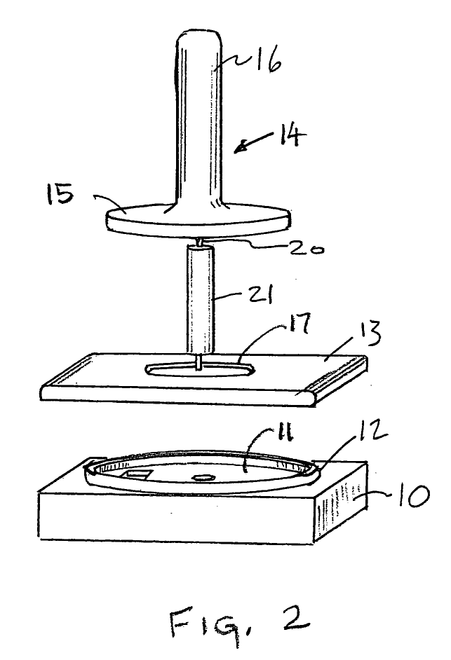

Referring to FIGS. 1 and 2, a base 10 supports a flat surface plate 11 that is circumscribed by a circular rim 12 rising from the plate 11. A cover 13 comprising another flat plate rests over the circular rim 12 thus enclosing a cylindrical space. A slider 14 comprising a flat circular plate 15 having a diameter less than the diameter of the rim 12 has a hollow handle 16 rising from the flat circular plate and fixed thereto at the center of the plate. The cover 13 has circular hole 17 through which the handle passes. The slider plate positioned within the enclosed cylindrical space can be positioned relative to the base 10 and the cover 13 by grasping the handle and urging it in any direction. Since the handle does not tilt, no wrist strength is required to position the slider plate. To bring the handle automatically back to a home position when the handle is released, a flexible stem 20 is fixed to the base 10 in an upright position at the center of the cylindrical space defined by the rim 12. A coil spring 21 rests over the stem and is secured to the base. The coil spring extends up into the hollow handle in which it loosely slides. Thus, as the handle is moved from the home position, the coil spring and stem are deflected and the spring rides down in the hollow handle. As soon as the handle is released, the spring and stem recover to an upright position and the spring rides back up into the handle thus returning the handle to the home position.

Mounted in the base is a CCD camera 23 comprising a lens and a two-dimensional matrix detector which generates signals for each pixel in the matrix. An LED 22 illuminates the area upon which the camera is focused by lens 24. The output of the CCD camera 23 is a frame of pixel signals defining an image. By comparison of sequentially input images, the microprocessor-based controller can determine the movement of the slider plate in two dimensions as the handle of the slider plate moves away form the home position. Apparatus and methods for detecting movement are disclosed, for example, in U.S. Pat. Nos. 6,172,354 and 6,664,948 incorporated herein by reference. While no pattern is required on the imaged surface of the slider plate to determine the movement of the slider plate, a home marker of some type is preferably provided when the handle is at the home position.

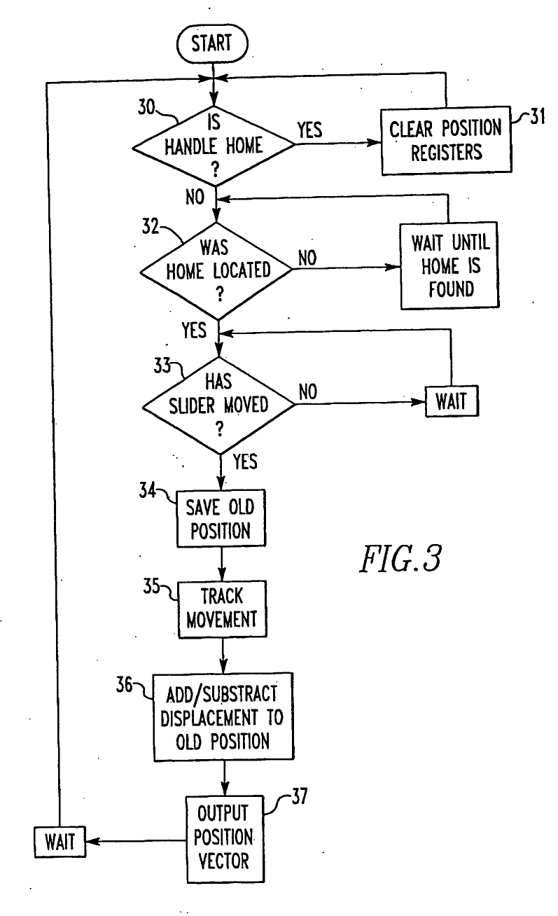

The method of detecting the displacement of the handle is shown in FIG. 3. At step 30, the image input from the camera is compared to the home image to determine if the handle is at home. If so, the position registers are cleared at step 31. If home was not previously detected at step 32, nothing is done until it is detected and the position registers are cleared. If home was earlier found, then a test is made to determine if the slider has moved at step 33. If it has not, the old position values remain in the position registers and the program awaits movement of the slider plate. If the slider plate has moved, the old position is sensed at step 34 and the extent of the displacement is detected at step 35 and added to the position registers at step 36. The values in the position register are continually output at step 37, for example, to the control system for the battery-powered wheelchair. After a short wait, the process is repeated.

Detecting rotation from the handle about its axis requires input from two cameras. According to a preferred embodiment, the cameras are positioned on perpendicular axes at right angles to each other and equidistant from the home position of the handle. (It is not necessary for cameras to be positioned exactly as set forth here, but doing so simplifies calculations.) If the movement sensed by both cameras is identical, then no rotation has taken place. If the movement sensed in one camera has a component which can be matched to a perpendicular movement sensed by the other camera, a rotation has taken place and the value of the component is indicative of the degree of rotation. The rotational steps are added or subtracted to provide a total angular orientation of the handle.

Having thus described our invention with the detail and particularity required by the Patent Laws, what is desired protected by Letters Patent is set forth in the following claims.

The invention claimed is:

1. A manually-operated control for generating a vector signal comprising:
first and second plates arranged in substantially parallel planes and being movable relative to each other in two directions while remaining substantially parallel;
a non-tilt handle connected to one of said plates for causing the relative movement of said plates;
a CCD camera fixed to one of said plates focused on the other plate; and
a microprocessor-based controller connected to input and process images sequentially input from said camera for detecting and quantifying the relative movement of the two plates in two directions and generating a vector signal indicative thereof.

2. A manually-operated control for generating a vector signal indicative of the displacement of a non-tilt handle and a scalar signal indicative of rotation of said handle comprising:
first and second plates arranged in substantially parallel planes and being movable in translation and rotation while remaining substantially parallel;
said handle connected to one of said plates with an axis substantially perpendicular to the plate to which it is connected for causing the relative translation and rotation movement of said plates;
two spaced CCD cameras fixed to one of said plates focused on the other plate; and
a microprocessor-controller connected to input and process images sequentially input from said cameras for detecting and quantifying the relative movement of the two plates in two directions and generating a vector signal indicative thereof and for detecting and quantifying the rotation of said handle about the axis thereof.

3. The manually-operated control according to claim 1 or 2, wherein the vector signal is comprised of two signals indicative of displacement from home in two directions.

4. The manually-operated control according to claim 1 or 2, wherein the vector signal is comprised of an angular direction signal and a displacement from home signal.

5. The manually-operated control according to claim 1 or 2, further comprising:
a housing supporting a third plate substantially parallel to the first and second plates, said third plate being in sliding contact with one of said first and second plates.

6. The manually-operated control according to claim 5, wherein the plate to which the handle is not connected has an opening therein through which the handle passes.

7. The manually-operated control according to claim 6, further comprising:
biasing means between the plate to which the handle is connected and the housing for urging the handle to return to a home position relative to the housing.

8. The manually-operated control according to claim 7, further comprising means for sensing that the handle is at or near the home position.

9. The manually-operated control according to claim 8, wherein the means for sensing that the handle is at or near the home position comprises a pattern on the plate on which a camera is focused.

10. The manually-operated control according to claim 1, wherein the scalar value of the vector signal is indicative of the distance of the handle from the home position.

11. The manually-operated control according to claim 5, wherein the plate to which the handle is attached has a circular shape and the handle is attached near the center of the plate.

12. The manually-operated control according to claim 11, wherein the housing provides a cylindrical cavity adjacent the third plate for restricting travel of the plate attached to the handle.

13. The manually-operated control according to claim 12, wherein the means for biasing is a coil spring extending along the axis of the handle and secured at one end to the housing.
